(19) United States
(12) Patent Application Publication
(10) Pub. No.: US 2013/0011229 A1
(43) Pub. Date: Jan. 10, 2013

(54) CARGO CONTAINER TRANSFER PALLET AND SYSTEM

(76) Inventor: Leonard D. Barry, Detroit, MI (US)

(21) Appl. No.: 13/545,644

(22) Filed: Jul. 10, 2012

Related U.S. Application Data
(63) Continuation-in-part of application No. 13/422,361, filed on Mar. 16, 2012.
(60) Provisional application No. 61/504,596, filed on Jul. 5, 2011.

(51) Int. Cl. B65G 67/02

(52) U.S. Cl. 414/340

(57) ABSTRACT

This pallet has rollers on a track and lilts for transferring a cargo container between vehicles or dock. Portable or extendable arms form the track for the pallet between adjacent vehicles or dock. Ledges on the vehicles support the arms and rollers. The pallet is moved from vehicle to vehicle or dock by driving the pallet with motor or the pallet can have one or more channels along its bottom engaged by a cam arm mounted on a vehicle to move the pallet between vehicles on either side. The pallet or air bags thereon lift the container. The pallet could optionally be lifted by extending its rollers lifting its supporting ledges and arms—so air bags do not need to be deflated or used to lift. As a safety feature the container is titled from and lowered to a vehicle only in register for transfer.

### CROSS-REFERENCE TO RELATED APPLICATIONS

This application is a continuation-in-part of U.S. patent application Ser. No. 13/422,361 filed Mar. 16, 2012, which claims priority of U.S. Provisional Patent Application No. 61/504,596 filed Jul. 5, 2011, the contents of which are incorporated herein by reference.

### FIELD OF THE INVENTION

The savings in transportation cost b railroads is well known, but they can do a lot better. Intermodal cargo containers are carried double stacked from port docks inland to hub centers often hundreds of miles past or before their destinations. At the inland hub center they are lifted off the railway cars by gantry cranes and set on large paved areas to wait for truckers that drive some over 250 miles to bring and receive a container. Most all the containers brought in by train to the inland hub center are transferred to truck chassis so container doors can be backed to dock doors built for trucks. The railroads can do better by transferring most of the incoming containers from double stacked trains to singe level spline cars and take them to or close to their destinations where they can be transferred along a street or siding by the truckers using this invention on their chassis.

By making container trailer chassis into self loaders, loaders as extra vehicles are eliminated. Trailer chassis that now park the containers end doors to dock doors can also transfer the containers (without modification to the containers) using these transfer pallets which can be interchanged between trailers and railway cars to serve on either and be left at a dock to eliminate long hauling them and making them more available where needed.

Trailer chassis for cargo containers are plentiful and available for use to receive and deliver the containers directly from railway cars and store, deliver, and dock them but it is done now mainly at huh centers with very costly equipment, site, labor, and long extra mileage.

### BACKGROUND OF THE INVENTION

This invention relates to my previously filed U.S. patent application Ser. No. 11/733,789 filed Apr. 11, 2007, which is now abandoned in favor of U.S. patent application Ser. No. 13/217,984 filed Aug. 25, 2011.

The loader for transfer of cargo containers in that application is replaced in this application by a pallet with rollers to run on a track between adjacent aligned, vehicles or between a vehicle and a dock.

### SUMMARY OF THE INVENTION

This new transfer system has the same major objects as that loader but with less investment and weight by eliminating the need for supporting its lift platform on a driveway and the need to steer it and move or drive it around on its own support wheels. This transfer pallet system eliminates the road wheels, steering, and their support frame of that loader.

It is an object to transfer the cargo container between a rail car and truck trailer side by side instead of a separate loader backing out away from the side of the rail car with the container to a distance for the trailer to be driven between the rail car and the loader and for the loader to move forward to load the container on the trailer and clear back and wait for the trailer to be driven away before the loader can be put back on the rail car—the procedure in my above mentioned earlier patent application.

it is an object to provide a low cost transfer system to transfer cargo containers between a rail ear and semitrailer chassis anywhere they can be conveniently aligned parallel and stopped for transfer.

It is an object that this new pallet and its track be stored at the transfer site or be carried on either vehicle under the space for the container.

The vehicles and dock have ledges under space for the container, a container berth, and removable transfer arms between aligned ledges to form a track for the pallet to roll across to transfer a container. The transfer arms are placed between the adjacent aligned vehicles along side of the ledges. It is an object to provide wide rollers on the pallets to bear the weight on either or both the ledges and arms where side by side.

It is an object to latch or ratchet the connecting arms between berths aligned for transfer to bridge and hold the vehicles apart to prevent them tipping toward each other when transferring a heavy load between them.

It is an object to lift and lower a cargo container on a pallet without lifting and lowering the frame of the pallet to prevent vertical scrubbing and catching of the pallet when between locating beds.

It is an object to provide inflatable lift bags on the pallets to conform to the shape of the underside of the container to lift and hold it in place during transfer.

It is an object to provide detachable transfer arms which can travel under the load or be kept at a transfer location and be replaceable with sets of arms of length for different spans.

It is an object to power these arms to swing out to help align adjacent vehicles.

It is an object to provide an electric powered pallet to drive itself on the portable track between vehicles or between either vehicle and a dock or ground level.

It is an object to provide transfer arms that extend from a pivot on one vehicle to a variable distance onto the other in a channel to align side by side against a ledge on the other to therewith form a transfer track to transfer the lift pallet between the aligned vehicles within an accepted distance tolerance apart.

It is an object to provide a low cost loader to transfer a cargo container between single level railway cars and trailer chassis so semitrailer trucks can dock the container as they do now—door end to dock.

It is an object to provide a side loading-unloading ramp and pallet for a cargo container.

It is an object to provide an extra set of long track arms to lower and raise the pallet to and from ground level with a tolerable slope fir the arms.

It is an option to provide motorized transfer arms to for a portable powered conveyor between the vehicles or vehicle and dock to transfer cargo containers therebetween on the pallet.

It is an object to provide a transfer pallet to work with a modified cam transfer system, see my U.S. Pat. No. 7,438,515.

It is an object to return the pallet to the semitrailer or railway car after each transfer to tether and keep it in house and available for transfer.

It is an object to transfer existing standard cargo containers by pallet without modification of the containers.

It is a further object to provide container transfer to and from either side of the vehicles.

It is an object to require alignment before lifting or lowering a cargo container with the pallet to keep in register for transfer.

It is an object either to be able to carry the pallet on a vehicle or leave it at a dock.

### BRIEF DESCRIPTION OF THE DRAWINGS

These other and further features and objects should become apparent to those skilled in the art upon study of this invention with reference to the drawings wherein:

FIG. 1 is a plan view of a semitrailer stopped in alignment along side of a railway container car with transfer arms extended between them for transfer of a transfer pallet between them.

FIG. 2 is a side elevation of the semitrailer with pallet shown above.

FIG. 3 is a side elevation of the railway car with a cargo container.

FIG. 4 is a perspective view of a transfer arm.

FIGS. 5 and 6 are plan and end views of the transfer pallet.

FIG. 7 is a sectional elevation of FIG. 1 taken on line 7-7 to larger scale with a transfer arm extended from the railway car.

FIG. 8 is a plan view of the railway car of FIG. 1 with transfer arms extended to a dock for transfer of as pallet.

FIG. 9 is a perspective view from above, the front of the dock.

FIG. 10 is a side view of a roller on a pallet to larger scale engaging the track on a ledge of either vehicle or dock and an arm.

FIG. 11 is a perspective view of end portions of two aligned vehicles with an arm extended to a ratchet ledge from the end of the railway car or semitrailer to the other vehicle.

FIG. 12 is a perspective of a longer arm supporting a pallet between a vehicle and the ground.

FIG. 13 is a perspective view of an end of a transport vehicle frame with a detached dog chain powered transfer arm with a line showing how to connect the arm onto the vehicle.

FIG. 14 shows the bottom end of a pallet for FIG. 13 with teeth for the dog engagement.

FIG. 15 is a broken plan view of two aligned vehicles with the powered transfer arms connected between them.

FIG. 16 is a sectional elevation taken on lines 16-16 of FIG. 15 with a pallet crossing the arm.

FIG. 17 is a side section view taken on line 17-17 of FIG. 15.

FIGS. 18 and 19 are respectively plan and side views of a motorized transfer track.

FIG. 20 is a plan view of a variation of the transfer pallet on a car aligned by transfer arms on a semitrailer and a cam arm to transfer the pallet.

FIG. 21 is a plan view of the cam operator for the semitrailer of FIG. 20 to larger scale.

FIG. 22 is a broken sectional view taken on line 22-22 of FIG. 20 to a larger scale.

FIG. 23 is a sectional elevation taken on line 23-23 of FIG. 20 to the larger scale.

FIG. 24 is another plan view of the railway car and a semitrailer with a variation of the cam transfer mechanism on the semitrailer engaging a transfer pallet on the car.

FIG. 25 is a sectional elevation taken on line 25-25 of FIG. 24.

FIG. 26 is a plan view of the railway car and semitrailer with a variation of the loader for transfer of a container on either side of the two aligned vehicles.

FIG. 27 is a section of FIG. 26 to show the side of the transfer arm.

FIG. 28 is a schematic of electric and air supply to air bags generally applicable.

FIGS. 29, 30 and 31 are respectively a cress sectional view on line 29-29 of FIG. 26 and its side projections when the pallet is lowered, and when raised by extending its rollers, generally applicable.

FIGS. 32, 33 and 34 are respectively a cross sectional view of a different lift on line 29-29 of FIG. 26 and its side projection when the pallet is lowered and raised, as way to lift the pallet by lifting its track on lift ledges, generally applicable.

FIG. 35 is a plan view or a variation of the pallet in phantom extended from a tractor trailer to the railway car.

FIG. 36 is a side elevation of the frame of the vehicle of FIG. 35 with pallet transferred to the semitrailer.

FIGS. 37 and 38 are sectional elevations respectively on lines 37-37 and 38-38 of FIG. 35.

FIG. 39 is a perspective view of these vehicles, FIGS. 35-38.

FIG. 40 is a bottom perspective view of the pallet of FIGS. 35-39.

FIG. 41 is a plan view of two vehicles and a dock aligned, the center vehicle extending a transfer arm to engage is pallet on the other vehicle.

FIG. 42 is a sectional view on line 42-42 of FIG. 41 to larger scale.

FIGS. 43-45 are plans of the cam arm respectively engaging, in, and disengaging the cam channel.

FIGS. 46 and 47 are respectively plan and side views of a portion of a vehicle showing cylinders for operating bridging arms.

FIG. 48 is a plan view of another variation of the loader.

FIG. 49 is a sectional elevation on line 49-49 of FIG. 48.

FIG. 50 Is a broken side view of a track arm with near side removed on larger scale.

FIG. 51 is a cross section on line 51-51 of FIG. 50.

FIG. 52 is a side view of a section of the track arm expended up.

FIG. 53 is a sectional view of a length of lift track secured on the vehicle.

FIG. 54 is a schematic of hydraulic controls for the loader of FIGS. 49-54.

FIG. 55 is a plan view of a transfer vehicle with a parallelogram linkage extending a pallet to a transport vehicle on the far side. This linkage holds the pallet in parallel for transfer to either side of transfer vehicle.

FIG. 56 is a side elevation of FIG. 55.

FIG. 57 is a plan view of two vehicles with a double parallel transfer linkage extending a pallet from one vehicle to the other.

FIG. 58 is a side elevation of FIG. 57.

FIG. 59 is a plan view of two vehicles with an oblique transfer key extended from one vehicle to engage a pallet o container or the second vehicle for transfer.

FIG. 60 is a perspective view of the key and its conveyor of FIG. 59.

FIG. 61 is a view in the direction of arrow 61 in FIG. 59.

FIG. 62 is a plan view of a first vehicle with an oblique parallelogram linkage about to engage an oblique transfer key into an oblique channel in the bottom of a pallet or container on a second vehicle for transfer to and from either side of the first vehicle.

FIG. 63 is a perspective view of the oblique parallelogram linkage and key of FIG. 62.

FIG. 64 is a view on arrow 64 of FIG. 62.

### DETAILED DESCRIPTION OF THE INVENTION

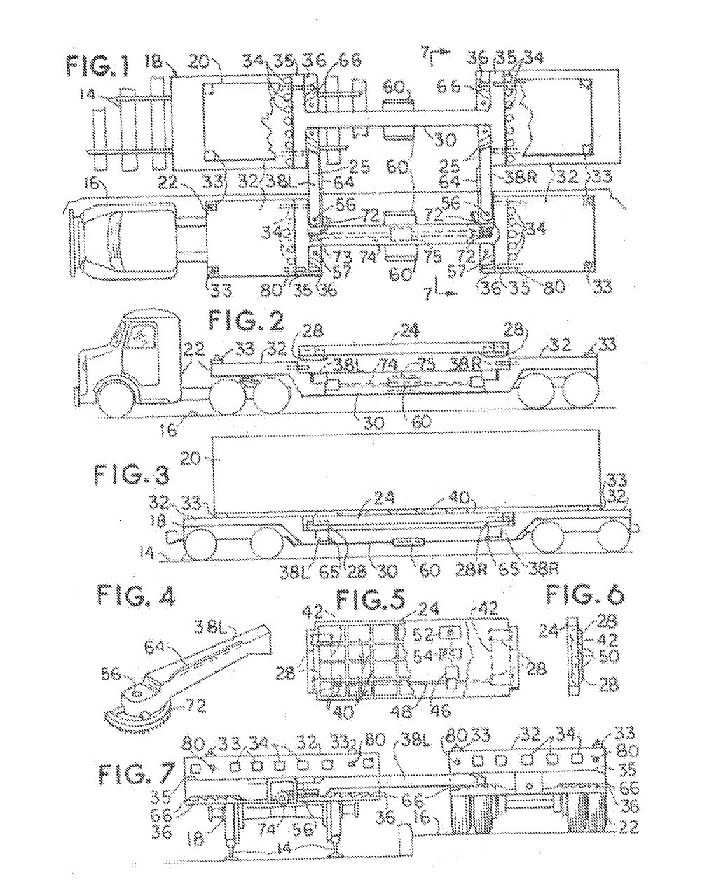

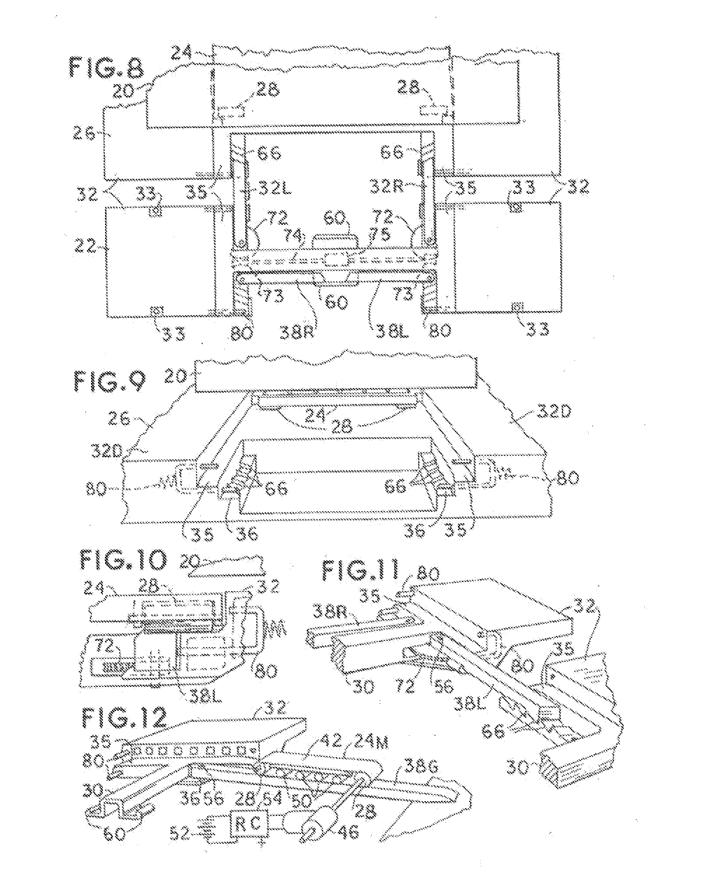

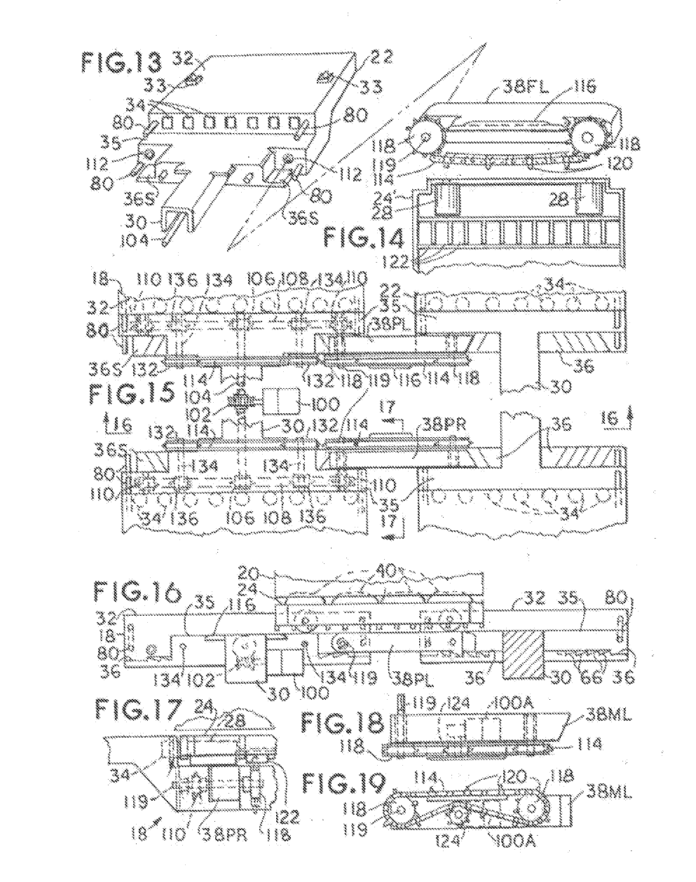

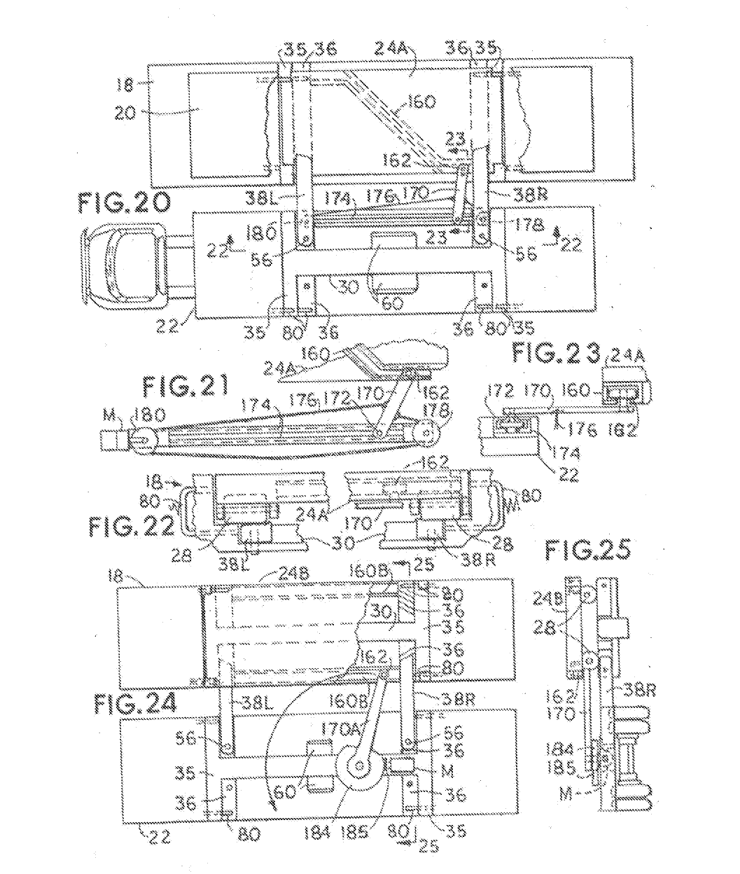

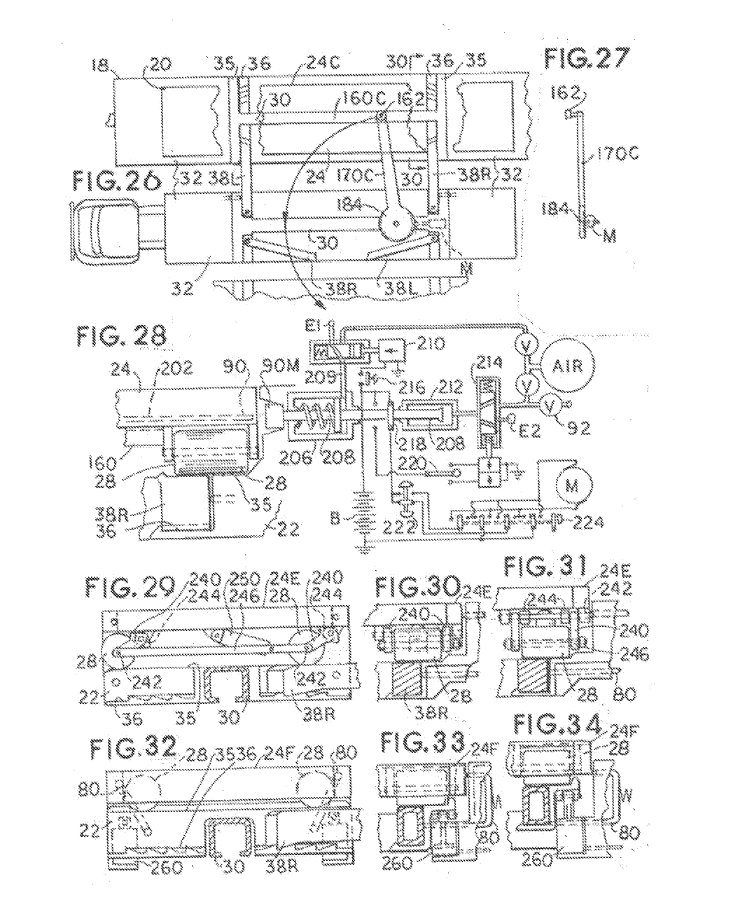

Referring to the drawings and in particular to FIGS. 1-11, track 14 along side of a level driveway area 16 has a railway container spline car 18 or equal stopped on track 14 for transfer of a cargo platform or container 20 between car 18 and a semitrailer 22 stopped in alignment and parallel with car 18. Container 20 is transferred on a lift transfer pallet 24 on a transfer track 25 connecting the railway car 18 and truck trailer chassis 22 or either to dock 26, FIGS. 8 and 9. Pallet 24 has a rectangular frame with corner supporting rollers 28 to roll on track 25 between vehicles 18 and 22, FIGS. 1 and 7, or either vehicle and dock 26, FIGS. 8-9.

Vehicles 18 and 22 each have a drop center frame or exposed center sill 30 with raised beds 32 spaced apart for pallet 24 to closely roll between. Beds 32 support the ends of container 20 on typical corner castings 33 for holding the container in place on beds 32. The facing sides of each bed 32 are at right angles to their vehicle faced with low friction material or vertical rollers 34 and have an upper ledge 35 below bed 32 to support rollers 28. A lower ledge or brackets 36 extend in from the bottom of each ledge 35 to each support a transfer arm 38L or 38R that spans between vehicles 18 and 22 to form track 25 with ledges 35. The top of arms 38L and 38R are substantially flush with the top of ledges 35 along where they lap side by side for rollers 28 to roll over both ledges 35 and arms 38L and 38R together forming track 25 for both ends of pallet 24.

Pallet 24 is substantially a container width wide or within the width limit for the semitrailer and of length to be guided between the end beds 32 of equal distance apart on each vehicle 18 and 22 to align with a container 20 on either vehicle and can stow under the container for travel on either vehicle. Pallet 24 has cross ribs that support an open floor such as flattened expanded metal to reduce weight and support air lift bags 40 that are deflated to be moved under container 20 and inflated to lift the container from corner castings 33 and impress and support the container from slipping on the pallet during transfer between vehicles or vehicle and dock.

There are various ways to roll or move the pallet on track 25.

Referring to FIGS. 5, 6, and 12, rollers 28 at each end of pallet 24 can be powered, lagged to increase traction, or connected by belt 42 or sprockets and roller chain to turn together. They are driven by reversible gearmotor 46 connected by shafting 48 to each end set of rollers 28, FIG. 5. Belt 42 is a toothed endless caterpillar belt run around each end set of toothed rollers 28 and under load cushioning rollers 50 as on an endless track drive at each end of the pallet to further increase traction. Gearmotor 46 is driven by battery 52 on the pallet or vehicle 18 or 22 or from an electric cord to local power and has radio controls 54.

Transfer arms 38L and 38R are the mirror image of each other and can be removable. Each has a vertical pivot pin 56 at their inner end that is engaged in a hole 57 in each lower ledge 36 of vehicles 18 and 22. The arms swing on pin 56 out to rest on ledges 36 of the aligned vehicle to form track 25. A bracket 60 on the side of sill 30 holds the outer ends of the arms when swung in transport on a vehicle 18 or 22. The arms can be lifted from bracket 60 at their outer end and swing out 90 degrees onto the lower ledge 36 of an aligned vehicle 18 or 22 or dock 26, FIG. 8. Each arm has an upward flange 64 along its inner side to guide rollers 28 on the arm in crossing the gap between berths. Lower ledges 36 have ratchet teeth 66 tapered in toward ledge 35 to block the arms from slipping. The outer ends of the arms are tapered to mesh on the ratchet teeth 66 on top of ledges 36 to hold the vehicles from tipping toward each other when transferring a heavy load. The outer ends of the arms and teeth 66 taper horizontally equally together inward toward ledge 35 to hold the arms from slipping off ledges 36. Teeth 66 can be press formed with openings to let dirt and water clear out.

Arms 38L and 38R extend and retract together by a worm drive. Each arm has a gear segment 72, FIGS. 1, 2, and 4, centered on removable pivot pin 56 and engaged by worm 73 secured on shaft 74 to a reversible gearmotor 75 to extend and retract the arms about 90 degrees.

The running top of arms 38L and 38R is slightly lower than ledges 35 to dear under rollers 28 and tapered down slightly at the ends. The outer ends of the top ledges 36 taper down to blend to the height of the arms. Slight variations in the height of the vehicles or vehicle and dock are tolerated because pallet 24 has ground clearance between end rollers 28 transversely across the pallet and holes are large enough for pins 56 to slope therein.

Dock 26, FIGS. 8 and 9, has two beds 32D spaced apart to support the ends of container 20, upper ledges 35 each as long, as the pallet is wide, and lower ledges 36 that need only extend far enough to support an arm 38L or 38R. Pallet 24 can serve like a convey to carry container 20 from a dock with ledges 35 extending as depressions or ramps to floor level into a warehouse or factory. Dock 26 has air pressure and electrical lines to operate the pallet.

Each pallet 24 has recessed corners, FIG. 5, for a keeper bolt 80, FIG. 10, to extend into through a hole in the vehicle or dock to hold the pallet from rolling or sliding off ledges 35. Keeper 80 is a round bar, U-shaped, with unequal sides standing on its longer side. Its short upper side extends out to engage in a recessed corner of the pallet. Its longer side extends through a hole in the wall up from the lower ledge 36 out into space for arm 38L or 38R. Putting or swinging arms 38L and 38R onto ledges 36 pushes keepers 80 in against spring pressure so the pallet, can be moved across the arms.

Arms 38L and 38R can be stored on the vehicles or at the dock. With pivot pin 56 in hole, as 38L or 38R can be swung in parallel to the vehicle over the depressed center platform or against the side of center sill 30 to be supported on latch bracket 60 sloped down to hold the arm against the center sill. Pallet 24 has eyes or hooks for ropes to pull the pallet if needed.

Referring to FIG. 12, longer arms 38G can replace arms 38L and 38R to extend from either vehicle to set the pallet and its load down to ground level. Arms 38G can be long enough to provide a slope that pallet 24 can mount.

### Operation

Trailer 22 is aligned adjacent and parallel to railway car 18 that has a container 20 shown in FIGS. 1-3, 7, and 16 to be transferred to the trailer. Pallet 24 is carried under space for the container on either the railway car or trailer. The inner ends of arms 38L and 38R are driven by motor 75 to be lifted on latch 60 and be pivoted out from one side of vehicle 22 onto ledges 36 of the aligned vehicle 18. With the semitrailer in neutral, its arms 38L and 38R are extended, shifting the trailer lengthwise into alignment with the railway car and retracting the keeper pins 80 behind the arms. The pallet can then be moved over the arms and aligned under container 20 on the railway car 18. Air is connected from railway car 18 through piping or hoses and quick-disconnect valve 90 to inflate air bags 40 to lift container 20 above locators 33. The quick-disconnect is disconnected with air held in bags 40. Motor 46 is connected in reverse to run the pallet with container across arms 38L and 38R to position on trailer 22. An air valve 92 is opened to deflate the air bags on the pallet to lower the container onto the bed of the trailer. The pallet is secured to the trailer 22 when the arms are lifted from ledges 16 on trailer 22, closing keepers 80. Arms are swung in to latch on bracket 60 against the center sill of the trailer. Likewise the container can be moved back to the railway car 18 and to and from dock 26 and the pallet put on the railway car or dock.

### Variations

Referring to FIGS. 13-19 for a variation in which the arms 38PL and 38PR are powered instead of or in addition to the pallet. If the arms are powered the powered pallet would have a clutch to put in neutral to be driven by the arms or the pallet's drive omitted. Arms 38PL and 38PR are driven by a reversible motor 100 on the railway car or semitrailer. Motor 100, FIG. 15, is shown on the railway car, connected by worm and gear 102 to shaft 104 run parallel to and supported by bearings along the center sill. A sprocket 106 on each end of the shall 104 each drives a roller chain 108 run between sprockets 110 each secured on a socket spline sleeve tube 112 bearing mounted one at each end and side of the vehicle under a ledge 35 to receive and drive the arm.

Arms 38PL and 38PR are similar to arms 38L and 38R except each have an endless chain 114 run over a support ledge 116 and around a sprocket 118 at each end along their exposed side. The sprocket 118 at the inner end of each arm is secured to a spline shaft 119 mounted in a bearing through the arm for engaging in spline socket tube 112 to drive chain 114 from the vehicle. The sprocket 118 at the outer end of each arm is on a stub shaft. Chains 114 have dogs 120 which engage in teeth 122 across the bottom of each end of the pallet, FIG. 14.

The frame of vehicle 18 or 22 selected for driving the arms, vehicle 18 in FIGS. 13, 15, and 16, has the ends of its frame shaped as in FIGS. 13 and 15 with short ledges 36S extending out each support an arm with pivot shaft 119 engaged in socket 112 so the arm can be inclined to accommodate differences in elevation between the beds of vehicles side coupled by the arms. The inner end of each arm 38PL and 38PR is a vertical semicircle centered on shaft 119 to allow tilt for height adjustment and is supported on ledge 36S to carry the weight on that end of the arm during transfer.

As a further feature a dog chain 114C is run transversely across car 18 at each end over center sill 30 in line with chain 114 on an arm and around end sprockets 132 each on a shaft 134 bearing mounted to the frame of the vehicle. A sprocket 136 secured on a shaft 134 engages chain 108 to drive chain 114C at each end of the berth from motor 100. The operation is similar as described for a powered pallet except the dog chains drive the pallet.

Referring to FIGS. 18 and 19 where arm 38ML representing arms 38ML and 38MR is motorized with a small reversible gearmotor 100A inside of each. These arms are the same as arms 38FL and 38FR except motor 100A is added and a sprocket 124 secured to its output shaft in mesh with drive chain 114. Shaft 119 is inserted in spline socket 112 on a vehicle to rotate in its bearings and support the arm. Chain 108 and sprockets 110 are omitted when this drive is used. These arms are electrically connected in parallel to be driven synchronized together from local power.

Other ways for moving the pallet include, cable pullers, capstands using cable in eyes in the pallet, motors in rollers 28, or teeth of powered sprockets engaging holes in the ends of the pallets and by cam arms as in FIGS. 20-28 and 30-40.

In FIGS. 20-23 pallet 24A has an oblique channel 160 open across the bottom for a earn roller 162 to move the pallet between vehicles 18 and 22A. Channel 160 is one of the same configurations as channel 34 on container 20 in my U.S. Pat. No. 7,438,515, FIGS. 1-25, to interchange therewith.

Pallet 24A is transferred between vehicles by cam roller 162 on the outer end of an actuating cam arm 170 engaged in pallet channel 160 to pull and push pallet 24A between the vehicles. Arm 170 is pivotally mounted on a roller 172 which rolls in channel track 174 secured along the transfer side of trailer 22A above arms 38L and 38R. Arm 170 is connected to wire rope 176 to run back and forth along track 174 between end stops. Rope 176 is connected to arm 170 near its midlength and run over end pulley 178 and drum 180 on the shaft of a reversible gearmotor M.

### Operation for FIGS. 20-23

To transfer container 20 from railway 18 to trailer 22A tractor-trailer 22C is approximately aligned and parallel with car 18 as shown in FIG. 20 and held in neutral while arms 38 are out folded using motor 75 to move arms 38L and 38R equally as in FIGS. 1-4. This can move the trailer to accurately align its container berth with that on the railway car. Brakes are applied on both vehicles. Arms 38 are then in ledges 36 releasing transfer side keepers stops 80. Air bags 40 remain deflated. Arm 170 is at the left end of track 174 with its cam roller 162 in the far left end of channel 160 on the pallet on the trailer. Gearmotor M is connected to drive arm 170 to the right, moving pallet 24C to a far stop 80 that under container 20 on car 18. Air bags 40 are inflated preferably as will be explained in FIG. 29, lifting container 20 clear of corner castings 34. Gearmotor M is reversed and driven to swing arm 170 counter-clockwise, moving cam roller 162 back along channel 160, pulling pallet 24A hack to the trailer where roller 162 pushes it on fully as it swings counter clockwise to the position shown in phantom FIG. 21 just over toggle. Air valve 92 is opened to deflate air bags 40 to set the container on the trailer. Pallet 24C is held in place by roller 162, and when arms 38L and 38R are withdrawn, keepers 80 hold the pallet.

To return container 20 to car 18, trailer 22 is aligned with car 18 as described. Arms 38L and 38R are swung into place on ledges 36. Air bags 40 are inflated, lifting container 20 clear off castings 35. Gearmotor M is reversed and connected, first pulling arm 170 counterclockwise because it overtoggled, pulling roller 162 in channel 160 to the right, pulling pallet 24A out untoggling arm 170 to swing clockwise by rope 176 to the end of track 174, having pulled roller 162 through channel 160, pushing pallet 24A with container 20 over arms 38 to align over car 18. The air bags are deflated setting the container in place on car 18. Gearmotor M is reversed to bring the pallet back to the semitrailer on which it is carried to its next job. Cam roller 162 stays in channel 160 holding the pallet in place until keepers 80 are all inserted by their springs when arms 36L and 36R are cleared from ledges 35.

### Further Variations

Referring to FIGS. 24 and 25, a long operating arm 170B is mounted on pivot 182 on the center line or vehicle 22 above arms 38L and 38R mounted to swing horizontally out straight from either side. Arm 170B has a beveled gear segment 184 integral and centered on its pivot and engaged by a beveled gear 185 on gearmotor M to swing can roller 162, engaged in channel 160B, to the left to pull pallet 24B onto vehicle 22 or push it off onto vehicle 18 when arm 170B is moved to the right. Channel 160B is secured legs down along the near side of pallet 24B. Again 162 is kept in channel 160B to tether pallet 24C to vehicle 22 and holds the pallet in place on vehicle 22 before keepers 80 extend when inns 36L and 36R are retracted.

Referring to FIGS. 26 and 27, pallet 24C has a straight cam channel 160C turned legs down alone center of its bottom engaged in by cam roller 162 on cam arm 170C pivotally mounted on the center line of vehicle 22 with gear 184. Gear 184 is again driven by gear 185 on the shaft or gearmotor M to swing arm 170C over 180° to transfer on both sides of the vehicle 22.

Referring to FIG. 28 for an arrangement to connect AIR to the air bags 40 applicable to all embodiments shown. Each pallet 24 has a quick-disconnect linearly connecting coupling fitting 90 at each end near the right-hand corner of each side with piping or hoses 202 to the air bags. Vehicles 18 and 22, and dock 26 have the mating coupler fitting 90M on the rod end of an air cylinder 206 mounted under bed 32 above ledge 35 aligned to engage in the mating fitting 90 on either end of pallet 24 when in register. Cylinder 206 has a hollow piston rod 208 open to its quick disconnect fitting 90M on its rod's end. Cylinder 206 is spring returned and connected by line 209 through solenoid valve 210 to AIR, or exhaust port E1 selective by the operator. The hollow piston rod of cylinder 206 extends through that cylinder into a second cylinder 212 and is open ended therein for air flow. Cylinder 212 is connected through a 3-way solenoid valve 214 to AIR, shut off, or exhaust E2. The solenoid of valve 210 is connected to a circuit across battery B in series with operator's switch 216. The solenoids of valve 214 are connected from battery B in series with operator's switch 218 and closed only when fitting 90M is extended part way to indicate engagement with fitting 90, three-position switch 220 to bottom coil of valve 214 to ground of battery B. For safety reasons air can be connected to pallet 24 and exhausted only when aligned in transport position on either vehicle 18 or 22. That is where fittings 90 and 90M line up and where a fitting 90M is extended the distance indicating it has entered a fitting 90 on a pallet, closing left-hand contacts with limit switch 218 to enable inflation or deflation of the air bags according to the coil of solenoid valve 214 engaged by the operator closing reverse switch 220 to that coil. If fitting 90M is extended more or less than into fitting 90, a pallet 24 is not positioned to inflate or deflate the air bags and limit switch 218 is open.

The quick-disconnect 204 must be disconnected and retracted before the pallet can be moved. Therefore motor M is connected through right hand contacts of limit switch 218 closed when quick-disconnect 90M is in retracted position shown, and switch 222 opened by keeper 80 at end of track 25 and operator's reverse switch 224.

Solenoid 210 is extended by a circuit battery B, operator's switch 216, coil of solenoid 210 to ground, connecting AIR to cylinder 206, pushing fitting 90M out to connect to fitting 90. Then when the operator presses down the 3-position switch 220 a circuit is completed from battery B, left hand contacts of limit switch 218, switch 220, lower coil of solenoid 214 to ground to pull valve 214 down, connecting AIR to cylinder 212 to inflate the air bags. When the operator releases switch 216, valve 210 shifts to exhaust cylinder 206, disconnecting 90M from fitting 90 sealing air in bags 40.

If quick-disconnect 90M is extended without engaging in a pallet it does not extend the correct amount, leaving right limit switch 218 open to prevent motor M from moving the pallet. When quick-disconnect 90M is extended into 90, right limit switch 218 is again in open position preventing motor M from moving the pallet. Thus the air bags cannot be inflated or deflated except through the quick-disconnect limit switch 218, assuring accurate positioning of the pallet for transfer of a container to or from each vehicle. This also prevents the pallet being moved by motor M against an extended quick-disconnect. By limiting the inflation and deflation of the air bans through the quick-disconnect coupling this ensures that the pallet is in register for transfer of the containers whenever lifted or set down by the air bags.

Refer to FIGS. 29-31 for a way to lift and lower the pallet on rollers 28. Each roller 28 is mounted between the outer ends of two lift links 240 whose inner ends are pivotally mounted to pallet 24E with rollers 244 between on a shaft to swing up and down. Links 240 have a bird-head shaped inner end with flats to hold the link in fully up and down positions. The two rollers 28 on each end of the pallet are connected by a link 246 to swing as a parallelogram linkage. Rollers 244 help reduce friction and carry weight when toggling between the flats on links 240. A double-acting hydraulic or air cylinder 250 is pivotally connected between the frame of pallet 24 and each link 246 to extend and retract rollers 28. Cylinder 250 is reversibly connected to pressure or exhaust at opposite ends of the cylinder on both ends of the pallet to lower or raise its rollers 28 together. The over toggle feature enables lift links 240 to remain in position without pressure in cylinders 250 when the pallet is run across arms 38L and 38R. Cylinders 250 are connected to a hydraulic or air hose from either vehicle 18 or 22 or at location for transfer.

Refer to FIGS. 32-34 for a way to lift and lower pallet 24 by lifting track 25 by lifting support ledges 35 and 36. Ledges 35 and 36 are connected and supported on hydraulic or air lift cylinders 260 at each end of the berth to be lifted together to lift the pallet to engage and lift a container.

By lifting and lowering a pallet by means such as shown in FIGS. 29-34 the air bags can be left inflated to provide locating cushions or other locators can be provided for securing the containers from slipping on the pallet during transfer.

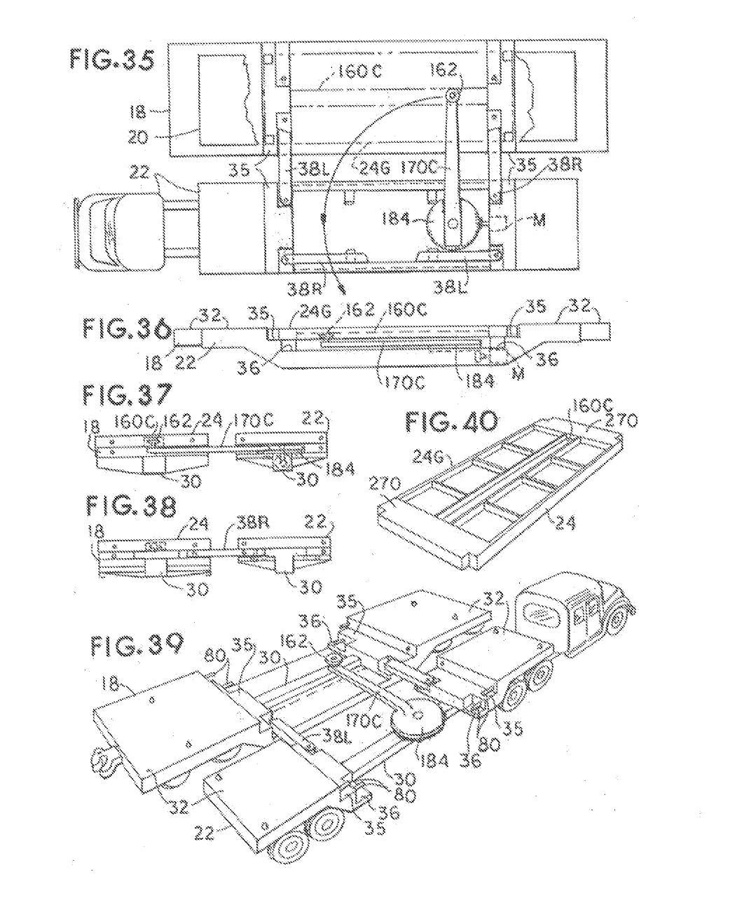

Referring to FIGS. 35-41, this variation is similar to FIG. 26 except rollers 28 are omitted reducing, the height of the pallet. This pallet 240 has smooth flats 270 across its bottom ends, FIG. 40, to be skid on track 25 between vehicles 18 and 22. Arms 38L and 38R are removable (lift off) and are not needed for light loads or when vehicles 18 and 22 are aligned closely spaced or in contact.

### Further General Details

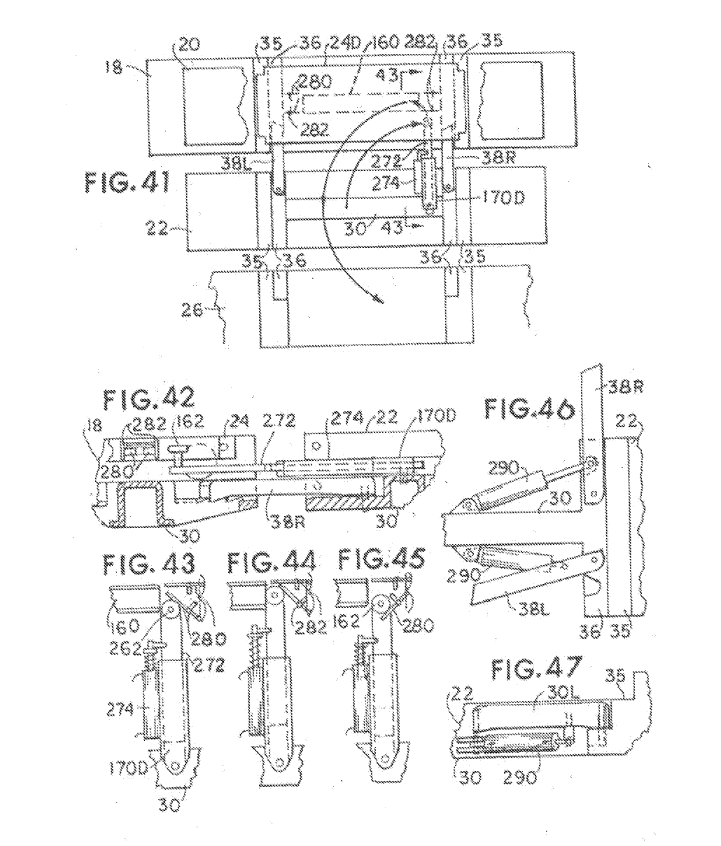

Referring to FIGS. 41-45 cam arm 170D is made to telescope to compensate for variation in distance between the vehicles aligned for transfer. Arm 170D also can be retracted from Channel 160D on pallet 24B when extended onto an adjacent vehicle 18 or 22 or dock 26. Central cam channel 160D of pallet 24D ends a distance from ledges 36 when on vehicles 18, 22, or dock 26 for can roller 162 to clear out from the channel when arm 170D is extended out beyond 90°. The arm has extension slide member 272 guided in and out on arm 170D, FIGS. 43-45. An air cylinder 274 with spring extension is secured along a side of arm 170D with rod end keyed to slide member 272 to extend the arm to engage in channel 160D on pallet 24D aligned on the adjacent vehicle or dock.

To aid this engagement, a swinging door 280 is pivotally mounted to open at each end of each side of channel 160D. Doors 280 close in line with the sides of the channel, and each is on a vertical shaft 282 on the far side of the door from the channel to swing in and out and up and down. Door 280 extends past shaft 282 to be a earn rider engaging a groove in the pallet that lifts the door in both directions of swing from parallel to the sides of the channel to let it close by gravity. Each door has an extension facing in from pivot shaft 282 to stop the door against the pallet when turned in about 45° to deflect the cam roller into the channel as in FIGS. 43 and 45. The door then drops to turn parallel to the channel.

With the pallet extended to a vehicle or dock cam arm 170D can be removed from channel 160D by turning the arm clockwise out from the channel and retracting it by pressuring cylinder 274 to shorten arm 170D to retract the cam roller opening a door 280 as it leaves the pallet, FIG. 43.

### Detail Operation

To insert cam roller 162 into channel 160D on a pallet aligned on a vehicle or dock, arm 170D is rotated clockwise and extended, by pressuring cylinder 274 to roll its cam roller along the near outside of the channel, defecting arm 170D to shorten until its cam roller rolls onto the end door, and cylinder 274 extends arm 170D pushing cam roller 162 to open the door about 45° deflecting the cam roller into the channel, FIGS. 43 and 44. The door is closed by gravity. Arm is driven counterclockwise into channel 160D to where the pallet is relieved of transverse force from arm 170D when full extended.

To remove arm 170D from channel 160D, the arm is driven clockwise out the end of channel 160. Cylinder 274 is pressured to shorten arm 170D to retract roller 162 pushing the near door open, FIG. 45. The shortened arm 170D is driven counterclockwise away from the end of the channel and cylinder 274 is relieved of its pressure as the arm is turned parallel to its vehicle.

When cam roller 162 is in pallet channel 160D, FIG. 41, arm 170D can be turned to transfer the pallet to or from the vehicle or dock aligned on either side of vehicle 22, as indicated by the curved arrows.

Referring to FIGS. 46 and 47, arms 38L and 38R on opposite sides of vehicles 18 or 22 each can be selectively extended and retracted by hydraulic cylinders 290 one on each side of center sill 30 at each end of the space between facing beds for the pallet. Cylinder 290 is pivotally connected between the frame of the vehicle and an arm 38L or 38R to extend and retract that arm to select either side of the vehicle for transfer. Ledge 36 is cut away for the rod end of cylinder 290 to clear. This arrangement is generally applicable.

Putting the rollers 20 on the pallet 24 for transfers should cut the cost and weight over putting rollers along on tracks 25 for the pallet.

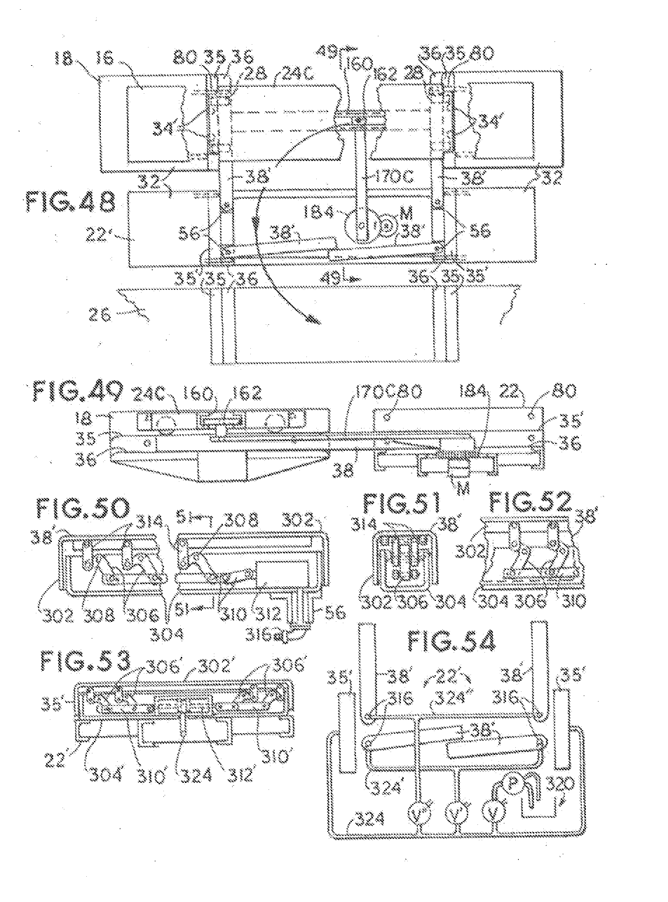

Referring to FIGS. 48 and 49 for an improved variation of this transfer system, transfer arms 38′ are lengthened to extend from semitrailer 22′ to reach all the way under rollers 28 on a pallet 24C aligned on a railway car 18 or other vehicle or dock. Ledges 36 are cleared for arms 38′ to extend thereon across vehicle 18 so its ledges 35 do not need to lilt. Arm 170C is pivot mounted substantially on the center line of the trailer 22′ and rotated or extended as described, see FIG. 24. Arm 170C has a cam roller 162 pivotally mounted on top of its outer end engaged in center channel 160C in pallet 24C. Arms 38′ are swung out or put in place on ledges 36 by any means as described, and extended short of for keepers 80.

Referring to FIGS. 48-54, preferably arms 38″ lift and lower the pallet. The arms resting on ledge 36 expand upward to lift the pallet. Arms 38″ have a top channel 302 turned legs and ends down lit to slide up and down on a bottom channel 304 turned legs and ends up along the inner sides and ends of the top channel. A series of bellcranks 306 (2 or more) are connected on pivots 308 along the lower channel 304 with their long arms down connected by links 310 to the rod end of a hydraulic cylinder 312 secured to channel 304 to swing the bellcranks. The shorter ends of bellcranks 306 are each pivotally connected by a link 314 to the upper channel 302 so when cylinder 312 is pressured it lifts the upper channel of arm 38′. Cylinder 312 is piped through a hollow pivot 56 and rotary fitting 316. The weight of the pallet on extended arms 38″ can tip the vehicles slightly to lay the arms 38′ flat on ledges 36. Arms 38′ are not long enough to hit the far side stops 80 so these are not pushed in to release a pallet off the wrong side (see top of FIG. 48)

Whenever arms 38′ are lifted on either side of vehicle 22′ ledges 35′ are lifted to complete track 25 for movement of the pallet thereon. Ledges 35′ are constructed to lift like arms 38′ and to the same level. As shown in FIG. 53, ledges 35′ each have a top channel 302′ that slips up and down over a lower channel 304′ secured to the frame of vehicle 22′. Channels 302′ and 304′ are connected to bellcranks 306 and links 314 and can be of the same cross section as arms 38′. Links 310′ connect the bellcranks to a cylinder 312′ secured to channel 304′ in each ledge to raise and lower the top channel 302′ of the ledge. Ledges 35 on vehicle 18 could be like ledges 35′ so arms 38′ can be shorter.

Truck 22′ has a hydraulic power supply 320, FIG. 54, connected through a 3-way valve V to line 324, to the head end of cylinders 312′ to lilt both ledges 35′ for a container on the pallet to clear over vehicle 22′. Line 324 is connected through 3-way valve V′ to line 324′ to the swivel joints 316 of both arms 38′ on one side of vehicle 22′ and through 3-way valve V″ to line 324″ to the swivel joints 316 on both arms on the opposite side of the vehicle. If ledges 35 on car 18 are also made to lift, arm 38′ can be of the same length as arms 38.

Pallets 24 and 24C can have end rollers 34′ FIG. 48. One is at each end corner instead of rollers 34, on the vehicles, to guide the pallet in and out between platforms 32.

### Operation for FIGS. 48-54

After arias 38′ are extended onto ledges 36′ by means such as described, the pallet on vehicle 22′ can be run under a container on vehicle 18 to stops 80 by clockwise rotation of arm 170C. The pallet is lifted by turning valves V and V′ or V and V″ to lift ledges 35′ and lift the extended arms 38′ to lift the pallet and any container thereon to clear over the vehicles. Arm 170C is rotated counterclockwise to roll the pallet and its load across the extended arms 38′ to far stops 80 on vehicle 22. Arms 38′ are lowered before retracting or extending them and before the vehicles are moved.

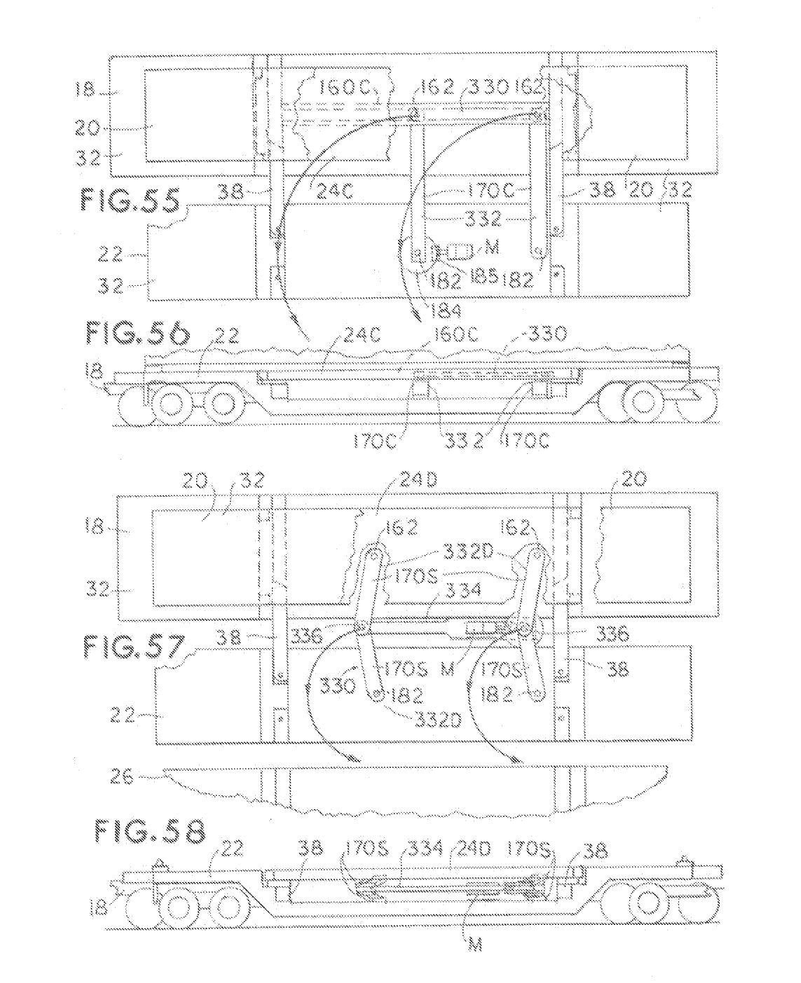

Referring to FIGS. 55 and 56 where there is room for two arms 170C spaced apart and pivotally secured at one end along the centerline of the base vehicle 22″ and parallelly connected pivotally at their outer ends by a link key 330 slip fit in channel 160C on the bottom of pallet 24C or container 20 to form a parallelogram linkage 332 driven by a gearmotor M with gear 185 engaged with gear 184 on arm 170C to extend and retract the pallet.

Key 330 slides in channel 160C and holds the pallet parallel to its vehicle 22 or 18 when the pallet is moved between vehicles 18 and 22″ to prevent twisting and jamming of the pallet along track 50 or on either vehicle. Parallelogram linkage 332 can extend to a pallet 24C on a vehicle or dock on either side of vehicle 22″. The vehicle and pallet could be otherwise as described. Arms 38 are optional if transfers are short and skids are used on the pallet instead of rollers 28.

Referring to FIGS. 57 and 58 where pallet 24D is connected (tethered) to vehicle 22 by two equal parallelogram linkages 332D stacked with a shared side 334 parallel to the vehicle 22. Each linkage 332D has end rotating link arms 170S pivotally connecting the two linkages at each end of common side 334 on pivots 336 so link anus 170S can be half the length of an arm 170 so they can be spaced further apart for holding the pallet more accurately parallel to vehicle 22. The shared link 334 is supported by links 170S to float. Two connected arms 170S each have a gear 184 on their shared pivot engaged by gear 185 between them on the shaft of gearmotor M to rotate the parallelogram linkages oppositely equally and to pass dead center position when aligned over vehicle 22 to transfer the pallet to and from a from vehicle or dock on either side of the vehicle 22.

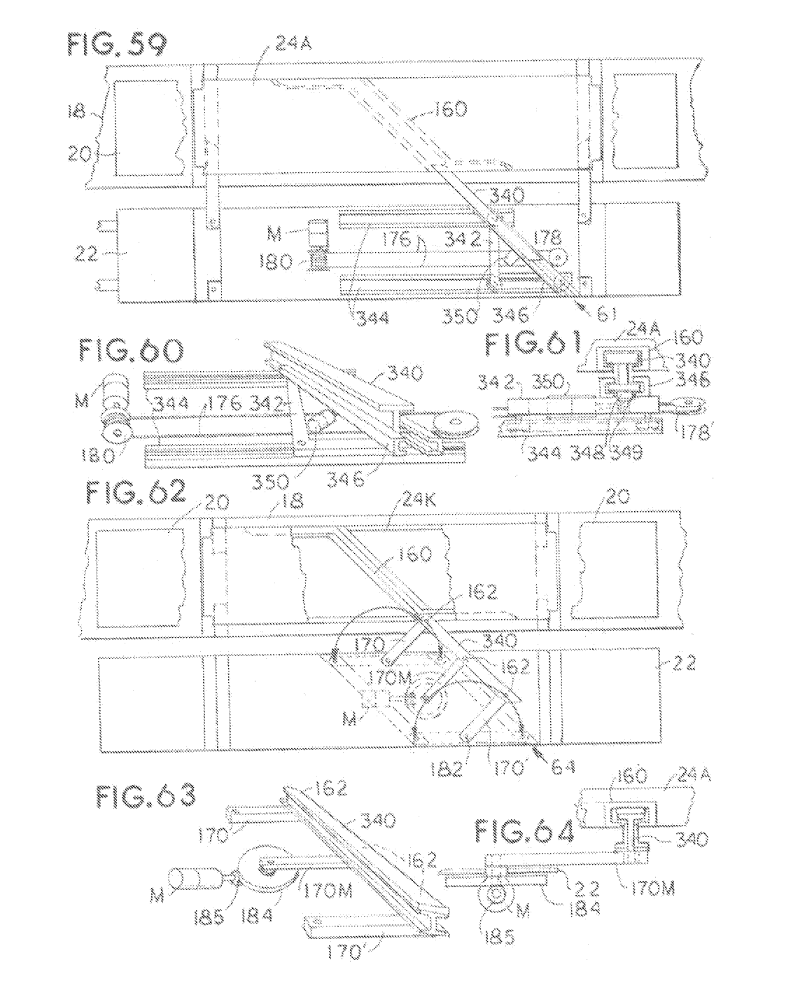

Referring to FIGS. 59-61 an oblique channel 160 is imbedded across the bottom of pallet 24A at about 45°. A key 340 is mounted to be extended out at the oblique angle on a carriage 342 mounted to move along track 344 along vehicle 22. Key 340 is extended out on a channel 346 on carriage 342 by gear rack 348 secured along the bottom of key 340 and engaged by the gear 348 on gearmotor 350 secured to carriage 342.

A cable 176 is attached to carriage 342, run to the left around drum 180 and back over pulley 178 at the right and back to carriage 342 on vehicle 22. Drum 180 is connected to gearmotor M secured to vehicle 22 to drive carriage 342 back and forth along track 344 while key 340 is held at the oblique angle.

When vehicles 18 and 22 are aligned as in FIG. 59 key 340 is extended against pallet 24A just ahead of channel 160 so when carriage 342 is driven to the left, key 340 engages in channel 160 and pulls the pallet or container onto vehicle 22. When moved back in the right the pallet or container is moved back off vehicle 22. The key can be extended from either side of vehicle 22 to transfer the pallet to or from either side and be left or taken back on vehicle 22.

Referring to FIGS. 62-64, vehicle 22 has an oblique parallelogram, linkage 350 set obliquely across the frame of vehicle 22 with equal arms 170′ pivotally connected between the vehicle's frame and a key 340 liar engaging in a channel 160 in the bottom of pallet 24K or container at approximately 45° when tangent to the curve of pivots.

This linkage is turned by a loosely pivoted middle arm 170M counterclockwise by motor M to slide the key up into channel 160 on the pallet or container and pull the pallet or container from vehicle 18 onto vehicle 22. Key 340 transfers the pallet or container back to car 18 in reverse and extends from either side of vehicle 22.

in FIGS. 55-64 key 340 or the wide stance between pivots 162 hold the pallet parallel to its vehicle so the pallet will not cock or jam.

Having thus described some embodiments and variations of my invention, I intend to cover by the claims all embodiments and variations within the true spirit and scope of this invention.

I claim:

1. A system for transferring a cargo container or the like between vehicles aligned substantially stationary and parallel relatively to each other, each vehicle having spaced apart elevated end platforms for supporting a cargo container thereacross, the combination: a pallet of substantially rectangular form sized for inserting in and out between said platforms for transfer of the cargo container, ledges on the acing end sides of said platforms that align between said vehicles to form a track fix said pallet to be transferred between vehicles, arms for inserting between vehicles to hold said vehicles apart, during transfer, lift means for lifting and lowering said container with said pallet to clear for transfer, means for holding the container in register on said pallet for transfer in register between said vehicles, ridged tethering and moving means for moving and keeping said pallet parallel to a said vehicle during transfer, and guide means for holding said pallet in line for transfer between said vehicles.

2. A combination as in claim 1, said tethering and moving means including a cam channel along the bottom of said pallet, at least two equal parallel horizontally rotating link arms pivotally connected to a said vehicle at a spaced distance apart a tie key in said earn channel pivotally connecting said link anus into a parallelogram linkage to hold said pallet parallel to said vehicle during transfer between said vehicles.

3. A combination as in claim 1, said tethering and moving means including at least one parallelogram linkage connecting said pallet to a said vehicle and mounted to extend the pallet to the other said vehicle and retract to run the pallet onto the vehicle to which it is tethered.

4. A combination as in claim 1, said tethering and moving means including two equal parallelogram linkages one mounted along the centerline of a said vehicle and the other mounted with its equal base along the centerline of the bottom of the pallet lengthwise the vehicle to align the pallet and vehicles, said parallelograms being connected by a common floating base link, and drive means for oppositely and equally revolving said arms of said linkages to extend and retract said pallet parallelly in line with said vehicles.

5. A combination as in claim 4, said drive means being secured on a said floating base link and connected to rotate said parallelogram linkages equally and oppositely.

6. A combination as in claim 1, said pallet having an oblique transfer channel across its bottom, said tethering and moving means including a carriage track along a said vehicle between said platforms, a carriage for travel along on said carriage track, a keyway channel seemed on said carriage set at the oblique angle (about 45°), means for moving said carrier back and forth along said carriage track, a transfer key bar in said keyway channel extendable from said keyway channel out from the side of said vehicle to engage in said oblique channel on said pallet to pull and push said pallet for transfer of a container between said vehicles.

7. A combination as in claim 1 said tethering and moving means including an oblique transfer channel secured across the bottom of said pallet at an angle of approximately 45°, a parallelogram linkage having a key link at the oblique angle, parallel rotating side arms pivotally connecting a said vehicle with said key link for swinging said key link on the oblique angle to meet said channel tangentially, a key carried on said key link said oblique angle to start engagement in said oblique transfer channel tangentially, and means to rotate said linkage side arms to engage said key in said channel and pull said pallet onto said vehicle for transfer of said container.
